(19) United States
(12) Patent Application Publication
(10) Pub. No.: US 2008/0173430 A1
(43) Pub. Date: Jul. 24, 2008

(54) HEAT DISSIPATION DEVICE WITH HEAT PIPES

(75) Inventors: ZHAO JIN, Shenzhen (CN); MENG FU, Shenzhen (CN); CHUN-CHI CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Taipei Hsien (TW)

(21) Appl. No.: 11/626,059

(22) Filed: Jan. 23, 2007

(51) Int. Cl. F28D 15/00; B32B 1/08

(52) U.S. Cl. 165/104.33; 428/34.1

(57) ABSTRACT

A heat dissipation device includes a base and a fin set thermally contacting the base. The base has a receiving portion for contacting to and absorbing heat from an electronic device and an extension portion surrounding the receiving portion. A first heat pipe is thermally engaged with the base. The first heat pipe is sinuous and includes a plurality of sections thermally engaged with the extension portion and the receiving portion of the base. A second heat pipe is thermally engaged with the extension portion and the receiving portion of the base. A middle linear section of the first heat pipe and an adjacent linear section of the second heat pipe are mounted to the base and located corresponding to the receiving portion of the base.

### BACKGROUND OF THE INVENTION

1. Field of the Invention

The present invention relates to heat dissipation devices for use in removing heat from electronic devices, and more particularly to a heat dissipation device incorporating heat pipes for improving heat dissipation efficiency of the heat dissipation device.

2. Description of Related Art

During operation of an electronic device such as a computer central processing unit (CPU) mounted on a printed circuit board, a large amount of heat is often produced. The heat must be quickly removed from the CPU to prevent it from becoming unstable or being damaged. Typically, a heat dissipation device is attached to an outer surface of the CPU to absorb heat from the CPU. The heat absorbed by the heat dissipation device is then dissipated to ambient air.

Conventionally, a heat dissipation device comprises a solid metal base attached to the CPU, and a plurality of fins arranged on the base. The base is intimately attached to the CPU thereby absorbing the heat generated by the CPU. Most of the heat accumulated at the base is transferred firstly to the fins and then dissipates away from the fins. However, as electronics technology continues to advance, increasing amounts of heat are being generated by powerful state-of-the-art CPUs. As a result, many conventional heat dissipation devices are no longer able to efficiently remove heat from these CPUs.

In order to overcome the above set out problems, a type of heat dissipation device illustrated as follows is used widely. The heat dissipation device comprises a base for absorbing heat from a heat generating electronic device, a heat pipe thermally combined to the base, and a plurality of fins arranged on the base. Generally, the heat pipe is linear. The base defines a corresponding groove receiving the heat pipe therein. In use, the base has a middle receiving portion thermally contacting with the electronic device and absorbing heat from the electronic device. The heat in the receiving portion of the base is absorbed by a middle portion of the heat pipe, and the heat pipe transfers the heat to end portions of the heat pipe and side portions of the base. The heat in the base then spreads to the fins to be dissipated to ambient air. However, the heat pipe is straight, which results that thermally contacting area between the base and the heat pipe is considerably small. Consequently, the heat in the receiving portion of the base cannot be transmitted to other portions of the base rapidly and evenly. The heat generated by the electronic device accumulates in the receiving portion of the base and the electronic device. Normal functions and abilities of the electronic device are adversely affected. Therefore, the heat dissipation device needs to be improved.

What is needed, therefore, is a heat dissipation device has a great heat dissipation capacity for an electronic device.

### SUMMARY OF THE INVENTION

A heat dissipation device in accordance with a preferred embodiment of the present invention is used for removing heat from a heat generating electronic device. The heat dissipation device comprises a base and a fin set thermally contacting the base. The base has a receiving portion for contacting and absorbing heat from the electronic device and an extension portion surrounding the receiving portion for distributing heat from the receiving portion thereto. A first heat pipe is thermally engaged with the base. The first heat pipe is sinuous and comprises a plurality of sections thermally engaged with the extension portion and the receiving portion of the base. A second heat pipe is thermally engaged with the extension portion and the receiving portion of the base. The first heat pipe includes two U-shaped portions. The second heat pipe has a U-shaped configuration and surrounds one the two U-shaped portions of the first heat pipe. A middle linear section of the first heat pipe and an adjacent linear section of the second heat pipe are mounted to the base at a location corresponding to the receiving portion of the base.

Other advantages and novel features of the present invention will become more apparent from the following detailed description when taken in conjunction with the accompanying drawings, in which:

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an exploded, isometric view of a heat dissipation device in accordance with a preferred embodiment of the present invention;

FIG. 2 is a partially assembled view of FIG. 1; and

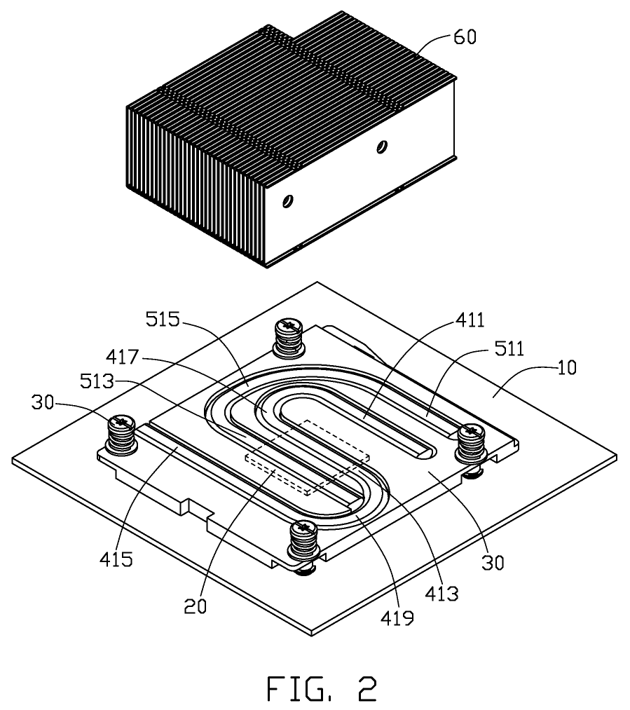

FIG. 3 is an assembled view of FIG. 2.

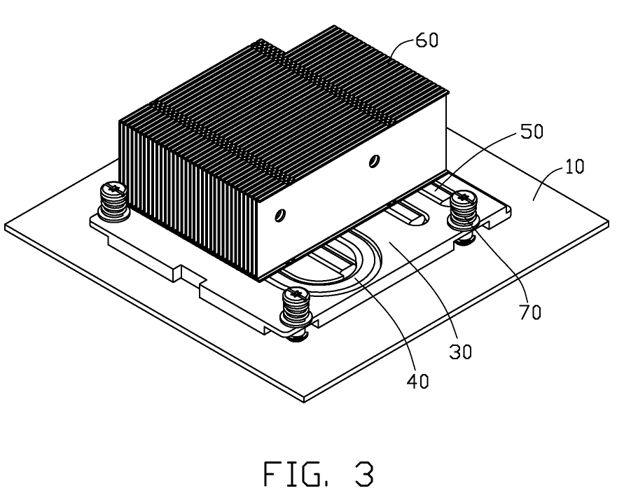

### DETAILED DESCRIPTION OF THE INVENTION

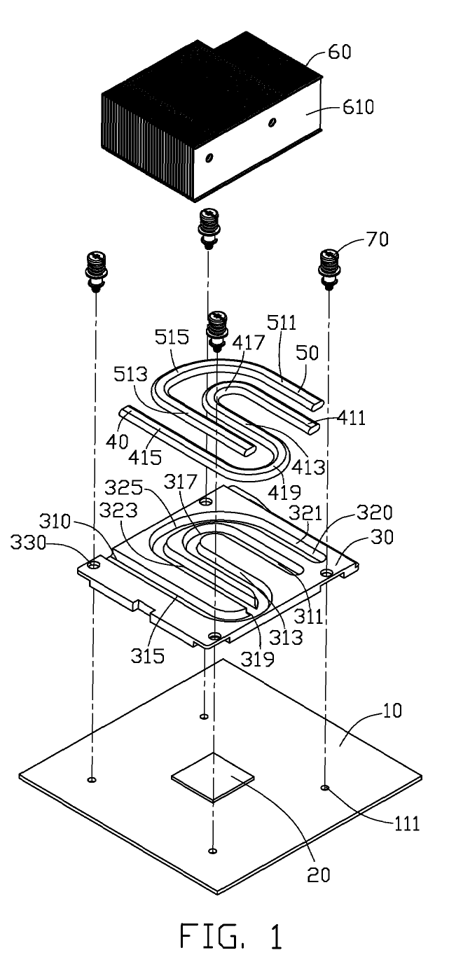

Referring to FIG. 1, a heat dissipation device in accordance with a preferred embodiment of the present invention is used for dissipating heat generated by a CPU 20 mounted on a printed circuit board 10. The heat dissipation device comprises a base 30, first and second heat pipes 40, 50 thermally arranged on the base 30, and a fin set 60 thermally contacting the base 30 and the heat pipes 40, 50.

The base 30 is a substantially rectangular metal plate having good heat conductivity, and has a bottom face (not labeled) for contacting the CPU 20 and a top face (not labeled) opposing the bottom face having the fin set 60 arranged thereon. A first groove 310 and second groove 320 are defined on the top face of the base 30 for receiving the first, second heat pipes 40, 50 therein. The first groove 310 is substantially S-shaped in profile, and comprises three parallel portions: a first linear portion 311, a second linear portion 313 and a third linear portion 315; the first groove 310 further comprises a first arced portion 317 connecting the first and second linear portions 311, 313, and a second arced portion 319 connecting the second and third linear portions 313, 315. The first, third linear portions 311, 315 are located at two opposite lateral portions of the base 30. The second linear portion 313 is located between the first, third linear portions 311, 315 in the base 30. Lengths of the first, second, third linear portions 311, 313, 315 increase gradually. The first, second arced portions 317, 319 are located at other two opposite lateral portions of the base 30, with the second arced portion 319 being located closer to a corresponding lateral side of the base 30. The first groove 310 defines two U-shaped portions in the base 30. The second groove 320 is substantially U-shaped, and comprises a first linear portion 321, a second linear portion 323 substantially parallel to the first linear portion 321, and an arced portion 325 connecting the first, second linear portions 321, 323. The second groove 320 surrounds one of the two U-shaped portions of the first groove 310 in the base 30, which means that the second groove 320 surrounds the first, second linear portions 311, 313, and the first arced portion 317 of the first groove 310. The first linear portion 321 of the second groove 320 is located outside of the first linear portion 311 of the first groove 310 in the base 30; the arced portion 325 of the second groove 320 is located outside of the first arced portion 317 of the first groove 310 in the base 30; the second linear portion 323 of the second groove 320 is located between the second and third linear portions 313, 315 of the first groove 310 in the base 30, but closer to the second linear portion 313 of the first groove 310. Four fixing holes 330 are defined in corresponding four corners of the base 30.

The first heat pipe 40 is substantially S-shaped in profile, and comprises three parallel sections: a first linear section 411, a second linear section 413, and a third linear section 415; the first heat pipe 40 further comprises a first arced section 417 connecting the first, second linear sections 411, 413, and a second arced section 419 connecting the second, third linear sections 413, 415. Lengths of the first, second, third linear sections 411, 413, 415 increase gradually. The second heat pipe 50 is substantially U-shaped in profile, and comprises a first linear section 511, a second linear section 513 parallel to the first linear section 511, and an arced section 515 connecting the first, second linear sections 511, 513.

The first, second heat pipes 40, 50 are received in corresponding first, second grooves 310, 320 of the base 30. The first, second, third linear sections 411, 413, 415 of the first heat pipe 40 are received in corresponding first, second, third linear portions 311, 313, 315 of the first grooves 310 of the base 30. The first, second arced sections 417, 419 of the first heat pipe 40 are received in corresponding first, second arced portions 317, 319 of the first groove 310 of the base 30. The first, second linear sections 511, 513 of the second heat pipe 50 are received in corresponding first, second linear portions 321, 323 of the second groove 320 of the base 30. The arced section 515 of the second heat pipe 50 is received in the arced portion 325 of the second groove 320 of the base 30. The first heat pipe 40 defines two U-shaped portions (not labeled) on the base 30. The second heat pipe 50 surrounds one of the two U-shaped portions on the base 30, which means that the second heat pipe 50 surrounds the first linear section 411, the first arced section 417 and the second linear section 413 of the first heat pipe 40. The first linear section 511 of the second heat pipe 50 is located outside the first linear section 411 of the first heat pipe 40; the arced section 515 of the second heat pipe 50 is located outside the first arced section 417 of the first heat pipe 40; the second linear section 513 of the second heat pipe 50 is located between the second linear section 413 and the third linear section 415 of the first heat pipe 40, but closer to the second linear section 413.

The fin set 60 comprises a plurality of fins (not labeled) assembled together. Each fin comprises a body 610 and top, bottom flanges (not labeled) extending from two opposite edges of the body 610. The top and bottom flanges of each fin abut a corresponding body 610 of an adjacent fin. The bottom flanges of the fins of the fin set 60 cooperatively form a bottom face thermally contacting the top face of the base 30 and the heat pipes 40, 50.

In use, the heat dissipation device is fixed to the printed circuit board 10 via a plurality of fasteners 70 engaged in corresponding fixing holes 330 of the base 30 and fixing apertures 111 defined in the printed circuit board 10. The bottom face of the base 30 thermally contacts the CPU 20, with the second linear sections 413, 513 of the first, second heat pipes 40, 50 corresponding to the CPU 20; therefore, the base 30 defines a heat receiving portion (not labeled) directly contacting the CPU 20 to absorb heat from the CPU 20 and having the second linear sections 413, 513 of the first, second heat pipes 40, 50 thermally engaged therewith. An extension portion (not labeled) is defined by the base 30, which surrounds the receiving portion. In this case, the receiving portion is not a central portion of the base 30, which means that the CPU 20 is not confronted with the central portion of the base 30. The receiving portion is off a center of the base 30. The extension portion of the base 30 has the first, third linear sections 411, 415, first, second arced sections 147, 419 of the first heat pipe 40 and the first linear section 511 and arced section 515 of the second heat pipe 50 thermally engaged therewith. The receiving portion of the base 30 absorbs heat from the CPU 20. Part of the heat in the receiving portion of the base 30 is transferred directly to the fin set 60 and the extension portion of the base 30, and part of the heat is mainly absorbed by the second linear sections 413, 513 of the first, second heat pipes 40, 50. The heat in the second linear section 413 of the first heat pipe 40 is transferred to the extension portion of the base 30 via the first, second arced sections 417, 419, first, third linear sections 411,415 of the first heat pipe 40. The heat in the second linear section 513 of the second heat pipe 50 is transferred to the extension portion of the base 30 via the arced section 515 and first linear section 511 of the second heat pipe 50. In this manner, the heat generated by the CPU 20 is evenly distributed in the base 30 by the first, second heat pipes 40, 50 rapidly. The heat in the base 30 reaches the fin set 60 and is dissipated to ambient air by the fin set 60.

According to the preferred embodiment of the present invention, the first and second heat pipes 40, 50 are mounted on the base 30 with the second linear sections 413, 513 of the first, second heat pipes 40, 50 located on the receiving portion of the base 30 corresponding to the CPU 20, and other sections 411, 417, 419, 415, 511, 515, of the first, second heat pipes 40, 50 located on the extension portion of the base 30 to distribute the heat generated by the CPU 20 over the base 30 evenly. Therefore, the base 30 is fully utilized. And the heat on the base 30 can be distributed to the fin set 60 evenly; the fin set 60 is also fully utilized. As a result, in comparison with the relate art, the heat dissipation device of the present invention has greater heat dissipation capacity for the CPU 20.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat dissipation device for removing heat from a heat generating electronic device, the heat dissipation device comprising:
a base for absorbing heat from the electronic device;
a first heat pipe thermally engaged with the base, the first heat pipe defining two U-shaped portions on the base;
a second heat pipe thermally engaged with the base, the second heat pipe surrounding one of the two U-shaped portions of the first heat pipe on the base; and
a fin set thermally contacting the base.

2. The heat dissipation device of claim 1, wherein the base comprises a receiving portion for absorbing heat from the electronic device and an extension portion integrally surrounding the receiving portion for distributing the heat in the receiving portion thereto.

3. The heat dissipation device of claim 2, wherein the receiving portion is off a center of the base.

4. The heat dissipation device of claim 2, wherein the first heat pipe comprises a first section thermally engaged with the extension portion of the base and a second section thermally engaged with the receiving portion of the base and a first connecting section connecting the first section and the second section.

5. The heat dissipation device of claim 4, wherein the first section, the second section and the first connecting section of the first heat pipe cooperatively define the one of the two U-shaped portions of the first heat pipe on the base.

6. The heat dissipation device of claim 4, wherein the first heat pipe further comprises a third section thermally engaged with the extension portion of the base, the third section connecting with the second section by a second connection section of the first heat pipe.

7. The heat dissipation device of claim 6, wherein the first section, the second section and the third section of the first heat pipe are linear, and have lengths thereof increased gradually.

8. The heat dissipation device of claim 6, wherein the second section, the second connecting section and the third section of the first heat pipe cooperatively define the other of the two U-shaped portions of the first heat pipe on the base.

9. The heat dissipation device of claim 5, wherein the second heat pipe comprises a first section thermally engaged with the extension portion of the base, a second section thermally engaged with the receiving portion of the base, and a connecting section connecting the first section and the second section.

10. The heat dissipation device of claim 9, wherein the first section, the connecting section and the second section of the second heat pipe cooperatively define a U-shaped configuration surrounding the first section, the first connecting section and the second section of the first heat pipe.

11. The heat dissipation device of claim 1, wherein the first heat pipe is substantially S-shaped in profile.

12. A heat dissipation device for dissipating heat generated by an electronic device, the heat dissipation device comprising:
a base comprising a receiving portion for contacting and absorbing heat from the electronic device and an extension portion surrounding the receiving portion for distributing heat from the receiving portion thereto;
a fin set thermally contacting the base;
a first heat pipe located on the base, and comprising a plurality of sections thermally engaged with the extension portion and the receiving portion of the base;
a second heat pipe thermally engaged with the extension portion and the receiving portion of the base;
wherein the sections of the first heat pipe on the receiving portion and the extension portion of the base cooperatively define at least a U-shaped portion on the base, the second heat pipe surrounds the at least one U-shaped portion of the first heat pipe on the base.

13. The heat dissipation device of claim 12, wherein the first heat pipe is substantially S-shaped in profile on the base.

14. The heat dissipation device of claim 13, wherein the first heat pipe comprises a first section thermally engaged with the extension portion of the base, a second section thermally engaged with the receiving portion of the base, a third section thermally engaged with the extension portion opposite to the first section, a first connecting section connecting the first section and the second section, and a second connecting section connecting the second section and the third section.

15. The heat dissipation device of claim 14, wherein the first section, the second section and the third section of the first heat pipe each are linear in shape.

16. The heat dissipation device of claim 13, wherein the second heat pipe is substantially U-shaped in profile on the base.

17. The heat dissipation device of claim 16, wherein the second heat pipe comprises a first section thermally engaged with the extension portion of the base, and a second section thermally engaged with the receiving portion of the base, and a connecting section connecting the first section and the second section.

18. A base of a heat dissipation device, comprising:
a metallic plate having a bottom surface with a receiving portion for thermally engaging with a heat-generating electronic component and an extension portion surrounding the receiving portion;
first and second pipes mounted on a top surface of the metallic plate, wherein the first heat pipe is substantially S-shaped including two U-shaped portions and the second heat pipe is substantially U-shaped and surrounds one of the two U-shaped portions of the first heat pipe; wherein
a middle linear section of the first heat pipe and an adjacent linear section of the second heat pipe are located corresponding to the receiving portion of the base, and other sections of the first and second heat pipes are located corresponding to the extension portion of the base.

19. The base of claim 18, wherein the receiving portion is off a center of the plate.
